(19) United States
(12) Patent Application Publication
(10) Pub. No.: US 2009/0090867 A1
(43) Pub. Date: Apr. 9, 2009

(54) NUCLEAR MEDICAL DIAGNOSIS APPARATUS

(76) Inventors: Norihito Yanagita, Hitachi (JP); Masahito Ooike, Noda (JP); Masami Nagaoka, Kashiwa (JP); Shigeru Kimura, Hitachi (JP); Fusaaki Kozawa, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/996,686

(22) PCT Filed: Mar. 30, 2007
(86) PCT No.: PCT/JP2007/057053

§ 371 Date: Jan. 24, 2008

(30) Foreign Application Priority Data
Mar. 31, 2006 (JP) 2006-098104

(51) Int. Cl. G01T 1/166; G01T 1/161

(52) U.S. Cl. 250/363.04; 250/363.02

(57) ABSTRACT

A nuclear medical diagnosis apparatus comprises a nuclear radiation detector for detecting a nuclear radiation generated by a nuclide arranged in a body of a subject, a correcting radiation applying mechanism for directing a correcting radiation generated by a correcting radiation source to the subject so that the correcting radiation passes through the subject to be detected by the nuclear radiation detector, and
an orbital mechanism arranged to rotate the correcting radiation applying mechanism to orbit around an body axis of the subject, and having a radiation source container by which the correcting radiation source is contained.

### TECHNICAL FIELD

The present invention relates to a nuclear medical diagnosis apparatus using radiation, and more particularly, to a nuclear medical diagnosis apparatus provided with a correction radiation source for carrying out medical diagnosis with a high degree of accuracy.

### BACKGROUND ART

Among nuclear medical diagnosis apparatuses that carry out medical diagnosis using radiation, a positron emission computed tomography apparatus (hereinafter referred to as “PET”) or a single photon emission computed tomography apparatus (hereinafter referred to as “SPECT”) is a technique of obtaining tomography by administering radiopharmaceutical to an examinee (patient) and measuring a distribution of this administered radiopharmaceutical in the body. Adopting such a technique enables molecular level functions and detection of metabolism and makes it possible to provide tomography based on physical functions.

As the radiopharmaceutical to be administered, the PET uses radiopharmaceutical containing a positron emitter (¹⁸F, ¹⁵O, ¹¹C or the like) and the SPECT uses radiopharmaceutical containing a single photon emitter (⁹⁹Tc, ⁶⁷Ga, ²⁰¹Tl or the like).

Here, PET will be explained as a representative example. The radiopharmaceutical (e.g., 2-[F-18]fluoro-2-deoxy-D-glucose, FDG) containing the positron emitter taken into the examinee's body has the nature of accumulating in a tumor tissue of the examinee by means of carbohydrate metabolism.

When the positron emitter is disintegrated at the accumulated position, it emits positrons (=β⁺), which couple with electrons of nearby cells and are annihilated. When a positron is annihilated in this way, a pair of γ-rays (radiation) each having energy of 511 keV are emitted in mutually opposite directions (180 degrees ±0.6 degrees).

The pair of γ-rays emitted in this way are simultaneously detected by two of many radiation detectors arranged around the examinee. Data detected in this way is accumulated, radiating positions (that is, positions where radiopharmaceutical is accumulated) are identified, imaged and it is thereby possible to identify the tumor region of the examinee.

However, radiation emitted from the emitter (positron emitter or single photon emitter) taken into the examinee's body in such a nuclear medical diagnosis apparatus is absorbed or scattered and attenuates in the process of traveling in the examinee's body. Such attenuation of radiation deteriorates the image quality of the examinee's tomographic image obtained.

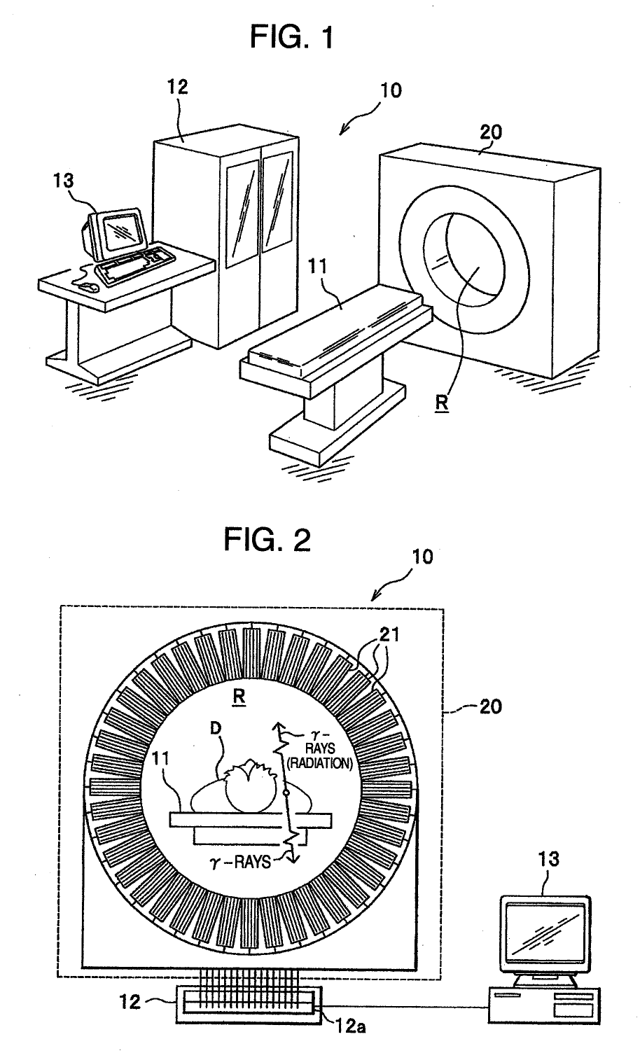

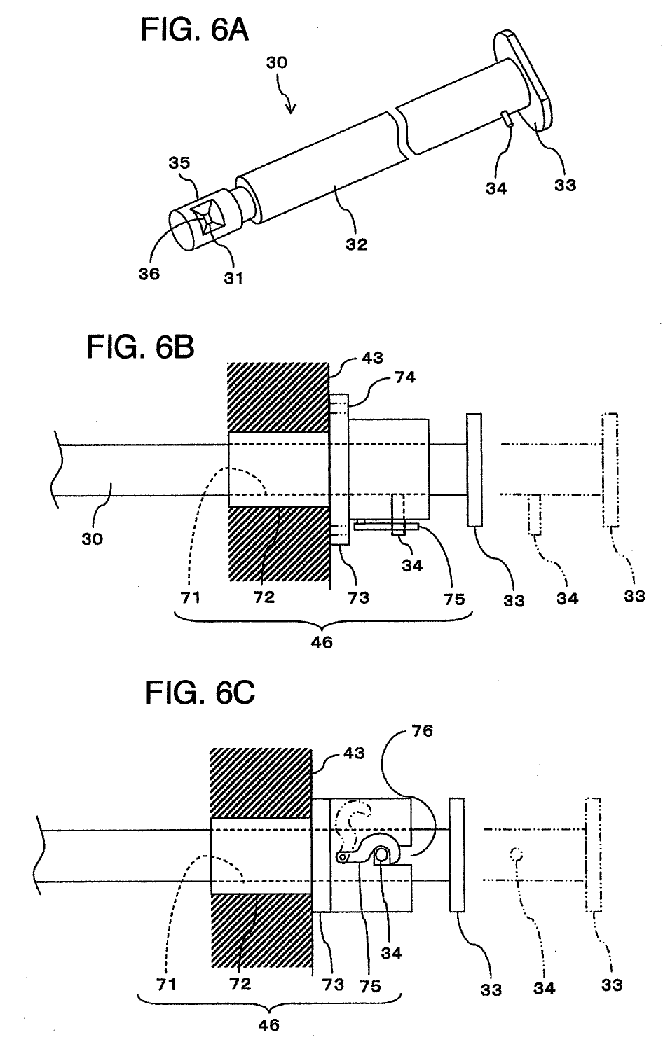

In order to correct such deterioration of the image quality, a correction process is provided in addition to an imaging process of detecting radiation emitted from the emitter taken into the examinee's body and obtaining a tomographic image. This correction process is a process of rotating a correction radiation source around the body axis of the examinee, irradiating the examinee with correction radiation and obtaining correction data for correcting for radiation attenuation and apparatus sensitivity (e.g., JP-A-8-338874 (especially see paragraph numbers 0002 and 0003, FIG. 1 and FIG. 6)).

### SUMMARY OF THE INVENTION

### Problem to be Solved by the Invention

However, to prevent diagnosis using the nuclear medical diagnosis apparatus from delaying, the correction process and switching between this correction process and imaging process need to be done speedily. On the other hand, when the nuclear medical diagnosis apparatus is in the imaging process, the correction radiation source should be retracted to a place sufficiently away from the radiation detector so that correction radiation leaking from the correction radiation source is not mistakenly counted by the radiation detector.

Furthermore, a series of operations of the correction radiation source need to be automatically performed from the standpoint of operability of the nuclear medical diagnosis apparatus and the operation thereof needs to be stable.

Attempting to satisfy these demands, switch between the correction process and the imaging process and continuously execute the process will complicate the operating mechanism of the correction radiation source and result in a problem that the size of the nuclear medical diagnosis apparatus inevitably increases.

Such an increase in the size of the nuclear medical diagnosis apparatus makes it difficult to introduce the nuclear medical diagnosis apparatus into a building such as a hospital where there are many spatial restrictions. Furthermore, when the size of the nuclear medical diagnosis apparatus increases and the inner diameter of the measuring space in which the examinee is inserted expands, the distance between the examinee and the radiation detector increases, detection sensitivity of radiation emitted from within the body deteriorates, resulting in a problem that the image quality of tomography obtained deteriorates.

The present invention has been invented to solve the above described problems and provides a nuclear medical diagnosis apparatus capable of automatically performing a correction process, and speedily and stably switching between this correction process and an imaging process without increasing the size of the apparatus.

In order to solve the above described problems, as described in claim 1, the present invention provides a nuclear medical diagnosis apparatus including a radiation detector that detects radiation emitted from an emitter taken into an examinee's body, a correction radiation mechanism that causes correction radiation emitted from a correction radiation source to pass through the examinee so as to be detected by the radiation detector, and a revolving mechanism that revolves the correction radiation mechanism around the body axis of the examinee and is provided with a radiation source chamber that accommodates the correction radiation source. Alternatively, as a substitute for claim 1, the nuclear medical diagnosis apparatus may also include a radiation detector that detects radiation emitted from an emitter taken into the examinee's body, a correction radiation mechanism provided with a correction radiation source that emits correction radiation for causing the correction radiation to pass through the examinee so as to be detected by the radiation detector, and a revolving member that supports the correction radiation mechanism, can revolve the correction radiation mechanism around the body axis of the examinee and includes a radiation source chamber that accommodates the correction radiation source.

Such a configuration of the present invention makes it possible to revolve the correction radiation source around the body axis of the examinee, irradiate correction radiation and execute a correction process. When this correction process ends, the correction radiation source is accommodated in the radiation source chamber provided in the revolving mechanism and the process can immediately move to an imaging process. Moreover, since this radiation source chamber is provided in the revolving mechanism, it never occupies a separate space. Furthermore, since the orbit of the revolving correction radiation mechanism can be set close to the radiation detector, it is possible to shorten the inner diameter of the measuring space in which the examinee is inserted.

The present invention provides the following effects. That is, the present invention provides a nuclear medical diagnosis apparatus capable of performing a correction process and switching from a correction process to an imaging process speedily and stably in a simplified configuration without increasing the size of the apparatus and obtaining the examinee's tomographic image of high quality.

Other objects, features and advantages of the present invention will be made clear in descriptions of the following embodiments of the present invention in relation to the attached drawings.

### BEST MODE FOR CARRYING OUT THE INVENTION

Preferred embodiments of a PET apparatus as a nuclear medical diagnosis apparatus of the present invention will be explained in detail with reference to the attached drawings as appropriate.

As shown in FIG. 1, the PET apparatus 10 of this embodiment is constructed of a bed 11, a data processing apparatus 12, a display apparatus 13 and an imaging apparatus 20.

The PET apparatus 10 configured in this way is designed to insert an examinee placed on the bed 11 into a measuring space R, detect γ-rays (radiation) emitted from tumor tissue using the imaging apparatus 20, carry out data processing on this detected signal using the data processing apparatus 12, identify points on the coordinate space generated by radiation, image this aggregate of points and display the image as tomography using the display apparatus 13. In this way, the PET apparatus 10 identifies the tumor region in the examinee's body.

On the other hand, when carrying out a medical diagnosis using the PET apparatus 10, it is necessary to carry out an imaging process for obtaining tomography to identify the tumor region and a correction process for obtaining correction data necessary to improve image quality of this tomography. This imaging process and correction process are executed with the examinee placed on the bed 11 being inserted in the measuring space R.

Explanations will be continued with reference to FIG. 2.

The bed 11 is designed to place the examinee D thereon and fix the examinee D so that the central axis of the measuring space R formed of cylindrically arranged radiation detectors 21 aligns with the body axis of the examinee D.

The examinee D is administered with, for example, FDG containing fluorine 18 (¹⁸F) whose half life is 110 minutes, positrons are emitted from fluorine 18 (¹⁸F) included in FDG accumulated in the tumor tissue of the examinee D by means of carbohydrate metabolism and γ-rays (radiation) are emitted, which are generated when these emitted positrons and nearby electrons are annihilated in pair.

The data processing apparatus 12 is designed to be able to accumulate data of the positions of the radiation detectors 21 where γ-rays (radiation) are detected, and pulse heights and detection times of γ-rays.

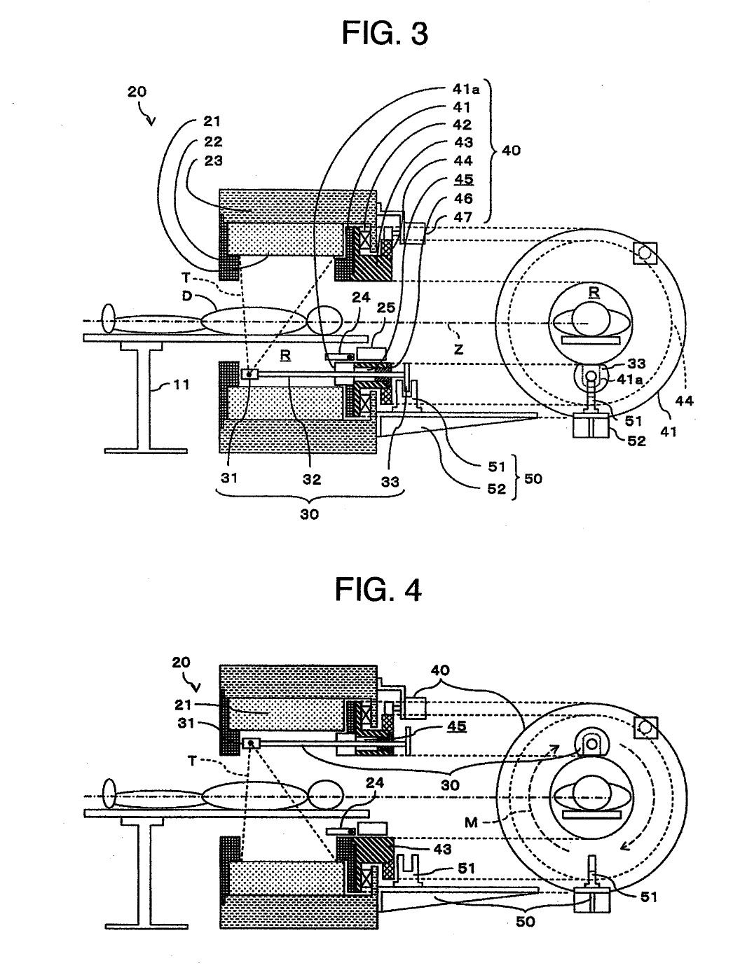

In the correction process, the data processing apparatus 12 accumulates pulse heights of correction radiation T which passes through the examinee D from a correction radiation source 31 (see FIG. 3) and is detected by the respective radiation detectors 21 as correction data. The pulse heights of the correction radiation T obtained in this correction process include information on an attenuation characteristic of radiation when passing through the examinee D.

Furthermore, in the imaging process, the data processing apparatus 12 detects γ-rays (radiation) emitted from within the examinee D's body and detected by the radiation detectors 21 at predetermined time intervals using a built-in simultaneous measurement apparatus 12a. The imaged data obtained in this way in the imaging process is subjected to predetermined correction calculation processing based on the above described correction data and points on the space coordinate where 511 keV γ-rays are generated are identified from two simultaneously measured locations of the radiation detectors 21.

The display apparatus 13 takes tomographic images of the identified points on the space coordinate, identifies the tumor region of the examinee D and performs various operations to carry out a predetermined medical diagnosis.

Explanations will be continued with reference to FIG. 3.

The imaging apparatus 20 is constructed of radiation detectors 21, a front-end shield 22, a housing 23, radiation source shields 24, 25, a correction radiation mechanism 30, a revolving mechanism 40 and a direct-acting mechanism 50.

The imaging apparatus 20 configured in this way is designed to insert the examinee D placed on the bed 11 into the measuring space R, detect γ-rays (radiation) emitted from within the body of the examinee D in the imaging process and output the above described imaged data necessary to create tomography to the data processing apparatus 12 (see FIG. 1).

Furthermore, the imaging apparatus 20 is designed to output the above described correction data necessary to recover the tomographic image quality which has been degraded due to attenuation when these γ-rays pass through the examinee D to the data processing apparatus 12 (see FIG. 1) in the correction process.

The radiation detectors 21 are designed to detect radiation emitted from an emitter taken into the body of the examinee D. This radiation detector 21 is configured such that the cylindrical hollow area formed of the plurality of radiation detectors 21 arranged on a circumference constitutes the measuring space R. The radiation detectors 21 consist of many detectors for detecting radiation (e.g., several tens of thousands to several hundreds of thousands) densely arranged from the plane contacting the measuring space R in the depth direction.

The radiation detectors 21 configured in this way are designed to detect positions at which a pair of γ-rays emitted from within the body of the examinee D in mutually opposite directions (180 degrees ±0.6 degrees) impinge on the outer surface of the measuring space R with high accuracy in the imaging process.

Furthermore, the radiation detectors 21 are designed to detect pulse heights of correction radiation T which pass through the examinee D to know an attenuation characteristic of γ-rays in the examinee D in the correction process.

The front-end shield 22 is made of a lead material having an excellent γ-ray shielding property and fixed to the housing 23 on a cylindrical structure made up of the circumferentially arranged radiation detectors 21, into which the examinee D is inserted.

The front-end shield 22 configured in this way is designed to shield disturbance entering from the outside of the measuring space R (e.g., γ-rays emitted from around the legs of the examinee D) into the radiation detectors 21.

The housing 23 contacts the grounding surface of the imaging apparatus 20 and mechanically supports other components of the imaging apparatus 20 so as to be arranged at relatively appropriate positions with respect to the bed 11 and examinee D.

Though the radiation source shields 24 and 25 are described in a simplified manner in the figure, these are arranged directly supported by the housing 23. At a position where the radiation source chamber 45 revolving around the body axis Z is located at the lowest point, the top surface radiation source shield 25 is located above this radiation source chamber 45 and the side radiation source shield 24 is located in an opening thereof.

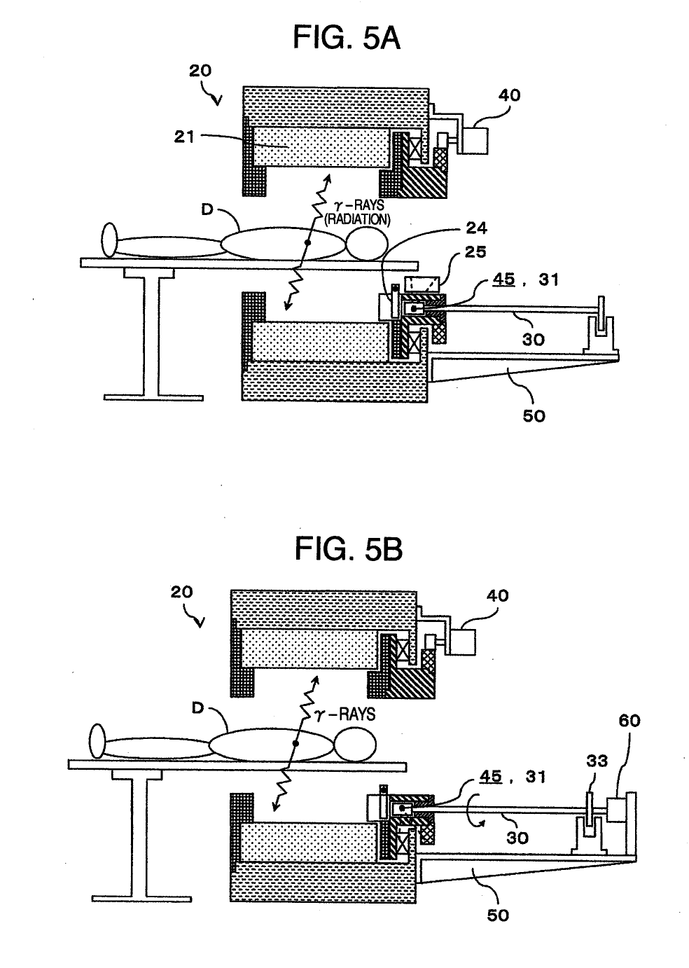

As shown in FIG. 4, this side radiation source shield 24 is substantially horizontally oriented when the radiation source chamber 45 is located at a position other than the lowest point and substantially vertically oriented as shown in FIG. 5A when the radiation source chamber 45 is located at the lowest point and the correction radiation source 31 is accommodated so as to close the opening of the radiation source chamber 45.

In this way, the radiation source shields 24 and 25 are arranged in the vicinity of the correction radiation source 31 when the correction radiation source 31 is accommodated in the radiation source chamber 45 and shield correction radiation emitted toward the measuring space R.

Returning to FIG. 3, explanations will be continued.

The correction radiation mechanism 30 is constructed of the correction radiation source 31, a radiation source support shaft 32 and a holding piece 33. The correction radiation mechanism 30 configured in this way is designed to cause correction radiation T emitted from the correction radiation source 31 to pass through the examinee D so as to be detected by the radiation detectors 21 in the correction process.

Furthermore, the correction radiation mechanism 30 is designed to cause the correction radiation source 31 to retract to the outside of the measuring space R to prevent correction radiation T from being irradiated onto the examinee D and radiation detectors 21 in the imaging process.

In this way, the attenuation characteristic of γ-rays needs to be examined using the correction radiation mechanism 30 because there is a difference in γ-ray detection efficiency detected by the radiation detectors 21 between γ-rays emitted from the surface of the examinee D and γ-rays emitted from the depth. This is because γ-rays emitted from within the body of the examinee D attenuate by being absorbed or scattered in the process of traveling inside the body. Such attenuation of radiation deteriorates the image quality of tomography of the examinee imaged.

Therefore, the tomographic image quality of the imaged data obtained by detecting γ-rays emitted from the examinee D using the radiation detectors 21 in the imaging process is improved by applying the correction data obtained by detecting correction radiation T which has passed through the examinee D using the radiation detectors 21 in the correction process.

The correction radiation source 31 is, for example, germanium 68-gallium 68 (⁶⁸Ge-⁶⁸Ga) having energy of 511 keV or cesium 137 (¹³⁷Cs) having energy of 662 keV.

The correction radiation source 31 configured in this way is designed to irradiate correction radiation T onto the examinee D and define the attenuation characteristic when γ-rays detected by the radiation detectors 21 pass through the examinee D.

The radiation source support shaft 32 is like a long spindle arranged substantially parallel to the body axis Z of the examinee D, to one end of which the correction radiation source 31 is fixed and at the other end of which the holding piece 33 which will be described later is provided.

The radiation source support shaft 32 is supported in a longitudinal direction by a shaft member 46 which will be described later to part of the revolving mechanism 40 in a freely variable manner.

The holding piece 33 is provided at an end of the correction radiation mechanism 30, held by a guide piece 51 when the revolving correction radiation mechanism 30 is located at the lowest point, to displace the correction radiation mechanism 30 in the longitudinal direction thereof according to the operation of the direct-acting mechanism 50. When the correction radiation mechanism 30 revolves and changes the position from the lowest point, the holding piece 33 is designed to release the holding of the guide piece 51, which will be described later.

The revolving mechanism 40 is constructed of a back-end shield 41, a rolling member 42, a rotation member 43, a meshing member 44, a radiation source chamber 45, a shaft member 46 and drive means 47. The revolving mechanism 40 configured in this way is designed to revolve the correction radiation mechanism 30 around the body axis Z of the examinee D in the correction process and also accommodate the correction radiation source 31 in the radiation source chamber 45 in the imaging process. When the revolving mechanism 40 operates in this way, the examinee D is irradiated with correction radiation T from all directions and the correction radiation T which has passed through the body impinges on the radiation detector 21 located symmetric to the correction radiation source 31 with respect to the body axis Z. The correction process is executed in this way.

The back-end shield 41 has a ring-like shape which is axially symmetric with respect to the body axis Z and is further located at a position symmetric to the front-end shield 22 across the measuring space R. The back-end shield 41 is fixed coaxially with the rotation member 43 which will be described later and designed to rotate around the body axis Z together with this rotation member 43. The back-end shield 41 is designed to prevent disturbance from entering the radiation detectors 21 from the outside of the measuring space R.

Furthermore, the back-end shield 41 is provided with a notched part 41a to allow the correction radiation source 31 accommodated in the radiation source chamber 45 to pass through.

The rolling member 42 is designed to couple with the housing 23 so that the rotation member 43 which will be described later rotates around the body axis Z. The rolling member 42 is preferably made up of a bearing or the like with high rigidity and with less vibration produced during rotation.

The rotation member 43 has a ring-like shape which is symmetric with respect to the body axis Z and is designed to rotate around the body axis Z in synchronization with the gear of the drive means 47 which is driven to rotate, engaged with the meshing member 44 provided on the circumference thereof.

The correction radiation mechanism 30 is supported on part of the rotation member 43 through the shaft member 46.

The rotation member 43 configured in this way revolves the correction radiation mechanism 30 along an orbit M as shown in FIG. 4 when driven by the drive means 47 (e.g., a motor) fixed to the housing 23. Together with this, the correction radiation source 31 supported at the tip of the correction radiation mechanism 30 also revolves around the body axis Z along the orbit M.

The radiation source chamber 45 is provided inside the rotation member 43 and is a space in which the correction radiation source 31 retracted from the measuring space R is accommodated. The notched part 41a of the back-end shield 41 is located at an opening of the radiation source chamber 45 communicating with the measuring space R and the side radiation source shield 24 is designed to be able to operate to open/close this opening when this radiation source chamber 45 revolves around the body axis Z and is located at the lowest point.

The shaft member 46 is provided on the side of the rotation member 43 on the opposite side of the above described opening of the radiation source chamber 45. The shaft member 46 supports the correction radiation mechanism 30 on the revolving mechanism 40 and supports the radiation source support shaft 32 so that the correction radiation source 31 displaces substantially parallel to the body axis Z.

The direct-acting mechanism 50 is constructed of a guide piece 51 and a straight track 52. The direct-acting mechanism 50 configured in this way is designed to displace the correction radiation mechanism 30 substantially parallel to the body axis Z.

The guide piece 51 is designed to hold the holding piece 33 of the correction radiation mechanism 30 which revolves around the body axis Z and is located at the lowest point and displace this correction radiation mechanism 30 substantially parallel to the body axis Z. When the correction radiation mechanism 30 located at the lowest point starts to revolve, the guide piece 51 releases the holding of the holding piece 33 and holds the holding piece 33 of the correction radiation mechanism 30 again when this completes the revolving.

The straight track 52 is fixed to the housing 23 and defines the direction of displacement of the guide piece 51 to the same direction as the body axis Z. The straight track 52 also has the function of not only displacing but also stopping the guide piece 51 at a predetermined position. This allows the correction radiation source 31 to be accurately positioned inside the measuring space R and accurately accommodated in the radiation source chamber 45.

Explanations will be continued with reference to FIGS. 6A to 6C.

As shown in FIG. 6A, the correction radiation mechanism 30 (see FIG. 3 as appropriate) is provided with a stopper pin 34, a radiation source holding member 35 and a radiation aperture 36 in addition to the above described correction radiation source 31, radiation source support shaft 32 and holding piece 33.

The stopper pin 34 is engageably inserted into an insertion part 76, which will be described later, provided in the shaft member 46 (FIG. 6C) to prevent axial rotation of the correction radiation mechanism 30 so that the radiation aperture 36 of the radiation source holding member 35 is fixed in the direction facing the examinee D (see FIG. 1).

The radiation source holding member 35 is made of a lead or tungsten material and is designed to accommodate the correction radiation source 31 therein. The radiation source holding member 35 is fixed to the tip of the radiation source support shaft 32 so that the radiation aperture 36 which communicates the part in which the correction radiation source 31 is accommodated with the outside faces the body axis Z in the measuring space R.

The radiation source holding member 35 configured in this way has the role of holding the correction radiation source 31, defining the traveling direction of the outputted correction radiation T in a predetermined direction and also suppressing leakage of radiation in any direction other than the defined direction.

As shown in a top view (FIG. 6B) viewed from the body axis Z and a side view (FIG. 6C), the shaft member 46 (see FIG. 3 as appropriate) is provided with a sliding surface 71, a cylindrical member 72, a fixing flange 73, an engaging member 75 and the insertion part 76, and is fixed to the rotation member 43 with a hole formed therein.

The sliding surface 71 is the inner surface of the cylinder-like cylindrical member 72 and is a portion that slides on the outer surface of the correction radiation mechanism 30 supported on the shaft member 46.

The cylindrical member 72 guides the correction radiation mechanism 30 which displaces in the longitudinal direction and also supports this correction radiation mechanism 30 on the rotation member 43. A notch of the insertion part 76 into which the stopper pin 34 provided in the correction radiation mechanism 30 is engageably inserted is provided at an end of the cylindrical member 72.

The fixing flange 73 is designed to fix the rotation member 43 and the shaft member 46 using a fastening member inserted into the fastening hole 74.

The engaging member 75 is designed to engage with the stopper pin 34 which is engageably inserted into the insertion part 76 and stop displacement of the correction radiation mechanism 30 in the longitudinal direction.

The insertion part 76 is the part into which the stopper pin 34 provided in the correction radiation mechanism 30 is engageably inserted and designed to stop axial rotation of this correction radiation mechanism 30.

### (Explanation of Operation)

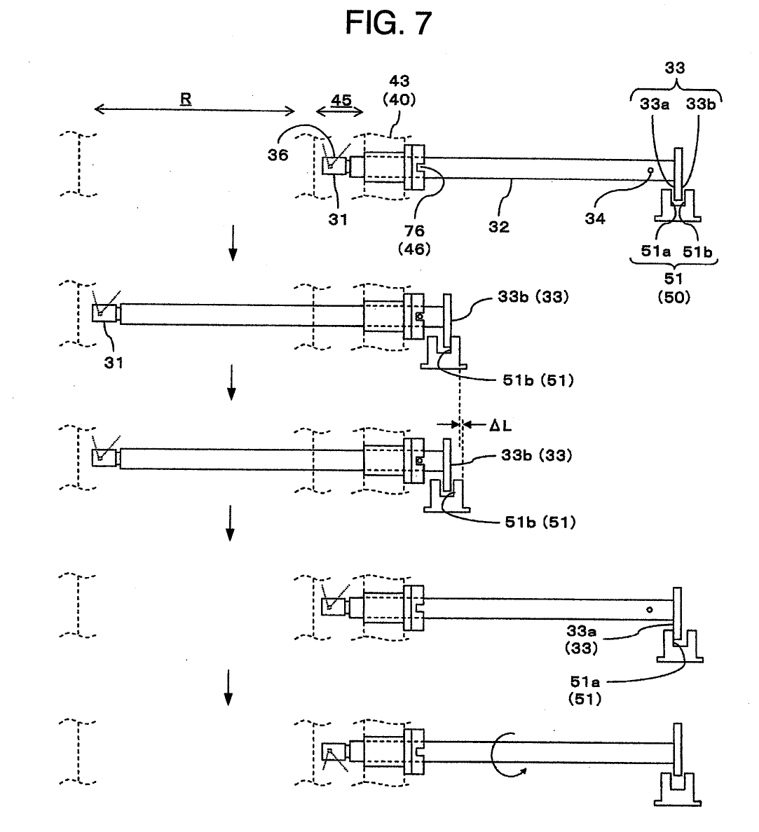

Next, the operation of the nuclear medical diagnosis apparatus according to the present invention will be explained with reference to FIG. 3, FIG. 4, FIG. 5 and FIG. 7. Here, explanations will be given in order of the correction process of acquiring correction data to improve image quality of tomography and then the imaging process of taking tomography of the examinee D. In the actual steps of a PET diagnosis, suppose this order of carrying out the imaging process and correction process or order of carrying out the correction process and administering radiopharmaceutical to the examinee D or the like is arbitrary.

First, in the correction process, as shown in FIG. 3, the bed 11 on which the examinee D is placed is inserted into the measuring space R. The direct-acting mechanism 50 is then driven to locate the correction radiation source 31 from the radiation source chamber 45 to the measuring space R. In this case, the correction radiation mechanism 30 is arranged in such a way that correction radiation T travels toward the examinee D.

The operation of the direct-acting mechanism 50 in this case will be explained with reference to FIG. 7. The correction radiation source 31 immediately before entering the correction process is accommodated inside the radiation source chamber 45 with the radiation aperture 36 face up as shown in FIG. 7. When the direct-acting mechanism 50 is operated from this condition and the guide piece 51 is displaced toward the measuring space R, a pushing surface 51b of the guide piece 51 pushes an outer end face 33b of the holding piece 33 to cause the correction radiation source 31 to go out of the radiation source chamber 45.

As shown in FIG. 7, the guide piece 51 stops when the correction radiation source 31 is located at a predetermined position of the measuring space R. Next, as shown in FIG. 7, the guide piece 51 displaces in the opposite direction by ΔL to release contact between the outer end face 33b of the holding piece 33 and the pushing surface 51b of the guide piece 51. Furthermore, the engaging member 75 (not shown; see FIG. 6C) engages with the stopper pin 34 and fixes the axial rotation of the correction radiation mechanism 30 and displacement in the longitudinal direction.

As shown in FIG. 4, the revolving mechanism 40 is operated and the correction radiation source 31 is made to revolve around the body axis Z along the orbit M with the emitted correction radiation T pointed toward the examinee D. This causes the correction radiation T to be irradiated onto the examinee D from all directions. The correction radiation T irradiated from all directions passes through the examinee D and is detected by the radiation detectors 21 and correction data for correcting for the attenuation characteristic of γ-rays in the examinee D is thereby obtained.

The revolving motion of the revolving mechanism 40 may be one revolution if the correction radiation T is scattered as shown by a dotted line in the figure and correction data is obtained three-dimensionally, but if the correction radiation T is not scattered and correction data is obtained two-dimensionally, the revolving mechanism 40 needs to be rotated several revolutions while displacing the correction radiation source 31 substantially parallel to the body axis Z. Alternatively, the displacement of the correction radiation source 31 in the body axis Z direction may be left as is and the bed 11 with the examinee D placed thereon may be displaced in the body axis Z direction.

When the revolving mechanism 40 revolves, completes the correction process and returns to the position of the lowest point, the holding piece 33 is held by the guide piece 51 again as shown in FIG. 7. The engagement between the engaging member 75 (see FIG. 6C) and the stopper pin 34 is released and the guide piece 51 is displaced in the direction opposite to the measuring space R as shown in FIG. 7. A lead surface 51a of the guide piece 51 then pushes an inner end face 33a of the holding piece 33 and causes the correction radiation source 31 to move to the radiation source chamber 45. The guide piece 51 stops when the correction radiation source 31 is accommodated in the radiation source chamber 45.

Furthermore, as shown in FIG. 7, when the correction radiation mechanism 30 is axially rotated by 180°, the traveling direction of correction radiation T is reversed and oriented opposed to the examinee D and radiation detectors 21, which makes it more difficult for the correction radiation T to impinge on the radiation detectors 21. As such a mechanism for axially rotating the correction radiation mechanism 30 by 180°, an inversion mechanism 60 as shown in FIG. 5B may be provided at an end of the direct-acting mechanism 50 and arranged so as to contact the holding piece 33 at a position at which the correction radiation source 31 is accommodated in the radiation source chamber 45. Provision of such an inversion mechanism 60 is preferable in the sense that the top surface radiation source shield 25 need not be provided or can be made thinner.

The correction process is completed in this way and the imaging process is started.

As shown in FIG. 5A, when correction radiation T is no longer emitted into the measuring space R, the process is continuously shifted to the imaging process. In the imaging process, the radiation detectors 21 count γ-rays emitted from the examinee D to thereby obtain imaged data necessary to take tomography of the examinee D. In this imaging process, correction radiation emitted from the correction radiation source 31 is never mistakenly counted (contaminated) by the radiation detectors 21, and therefore high quality tomography of the examinee can be obtained.

As explained above, the nuclear medical diagnosis apparatus 10 according to the present invention, since the radiation source chamber 45 in which the correction radiation source 31 is accommodated is provided in the revolving mechanism 40, the correction process and switching between this correction process and imaging process can be realized speedily. For this reason, even when the correction process and imaging process are repeated, this will never delay any diagnosis by the nuclear medical diagnosis apparatus 10.

Furthermore, when the nuclear medical diagnosis apparatus 10 is in the imaging process, since the correction radiation source 31 is accommodated in the radiation source chamber 45 surrounded by the radiation source shields 24, 25, the possibility that correction radiation may leak and may be mistakenly counted by the radiation detectors is decreased.

Furthermore, since a series of operations of the correction radiation source 31 accompanying the correction process and switching between this correction process and imaging process are automatically carried out, the burden on the operator who operates the nuclear medical diagnosis apparatus 10 can be reduced.

Furthermore, since the mechanism of operating the correction radiation source 31 is simplified, upsizing of the nuclear medical diagnosis apparatus can be avoided. Especially, since the notched part 41a is provided in the back-end shield 41 which rotates together with the revolving mechanism 40, the correction radiation mechanism 30 can be placed close to the radiation detectors 21. This allows the inner diameter of the cylindrical measuring space R into which the examinee D is inserted to be reduced, and therefore the distance from the examinee D to the radiation detectors 21 is shortened and it is possible to increase detection sensitivity of radiation emitted from within the body and improve the image quality of tomography obtained.

The PET apparatus has been explained so far as the nuclear medical diagnosis apparatus according to the present invention, but the nuclear medical diagnosis apparatus of the present invention is not limited to the PET apparatus and is also applicable to a nuclear medical diagnosis apparatus equipped with a correction radiation source in general. The present invention is also applicable to a SPECT apparatus, for example.

Although the present invention has been described with reference to the preferred embodiment, it is apparent to those skilled in the art that a variety of modifications and changes may be made without departing from the spirit and the scope of the present invention which is intended to be defined by the appended claims.

### BRIEF DESCRIPTION OF THE DRAWINGS

[FIG. 1] a perspective view showing an overall configuration of a PET apparatus showing an embodiment of a nuclear medical diagnosis apparatus of the present invention;

[FIG. 2] a drawing schematically showing a circumferential cross section of an imaging apparatus of the nuclear medical diagnosis apparatus according to the embodiment;

[FIG. 3] juxtaposed cross sectional drawings of the imaging apparatus taken along the body axis of the examinee and taken perpendicularly to the body axis to show one process of a correction process of the nuclear medical diagnosis apparatus according to the embodiment;

[FIG. 4] juxtaposed cross sectional drawings of the imaging apparatus taken along the body axis of the examinee and taken perpendicularly to the body axis to show one process of a correction process of the nuclear medical diagnosis apparatus according to the embodiment;

[FIG. 5A] a longitudinal cross-sectional view of the imaging apparatus taken along the body axis of the examinee to show an imaging process of the nuclear medical diagnosis apparatus according to the embodiment;

[FIG. 5B] a drawing showing an imaging process of a nuclear medical diagnosis apparatus according to another embodiment;

[FIG. 6A] a perspective view showing an embodiment of a correction radiation mechanism applied to the present invention;

[FIG. 6B] a top view of a shaft member applied to the present invention viewed from the body axis of the examinee;

[FIG. 6C] a side view of the shaft member in FIG. 6B; and

[FIG. 7] a drawing showing an operation flow of the correction radiation mechanism and direct-acting mechanism applied to the present invention.

1. A nuclear medical diagnosis apparatus comprising;
a nuclear radiation detector for detecting a nuclear radiation generated by a nuclide arranged in a body of a subject,
a correcting radiation applying mechanism for directing a correcting radiation generated by a correcting radiation source to the subject so that the correcting radiation passes through the subject to be detected by the nuclear radiation detector, and
an orbital mechanism arranged to rotate the correcting radiation applying mechanism to orbit around an body axis of the subject, and having a radiation source container by which the correcting radiation source is contained.

2. The nuclear medical diagnosis apparatus according to claim 1, wherein the orbital member includes a shaft supporting member for supporting a radiation source supporting shaft to which the correcting radiation source is fixed so that the correcting radiation source is movable substantially parallel to the body axis.

3. The nuclear medical diagnosis apparatus according to claim 2, wherein the shaft supporting member includes a receiving part into which an engaging pin arranged on the correcting radiation applying mechanism is inserted to prevent the correcting radiation applying mechanism from rotating on the shaft.

4. The nuclear medical diagnosis apparatus according to claim 3, wherein the shaft supporting member includes an engaging part capable of engaging with the engaging pin inserted in the receiving part to prevent the correcting radiation applying mechanism from moving substantially parallel to the body axis.

5. The nuclear medical diagnosis apparatus according to claim 1, wherein the nuclear radiation detector includes an end shield to prevent disturbance from being applied to the nuclear radiation detector.

6. The nuclear medical diagnosis apparatus according to claim 5, wherein the end shield has a notch through which the correcting radiation source passes to be contained by the radiation source container.

7. The nuclear medical diagnosis apparatus according to claim 1, further comprising a linear moving mechanism for moving the correcting radiation applying mechanism substantially parallel to the body axis.

8. The nuclear medical diagnosis apparatus according to claim 1, wherein the linear moving mechanism includes a guide part which holds a holder part of the correcting radiation applying mechanism when moving the correcting radiation applying mechanism, and which is released from the holder part when the correcting radiation applying mechanism is rotated.

9. The nuclear medical diagnosis apparatus according to claim 8, wherein after the guide part is stopped after moving in a direction to take the correcting radiation source out of the radiation source container, the guide part moves in another direction opposite to the direction to be released from the holder part before the orbital member rotates.

10. The nuclear medical diagnosis apparatus according to claim 1, further comprising a counter-rotating mechanism for rotating the correcting radiation applying mechanism to invert a radiating direction of the correcting radiation after the correcting radiation source is contained by the radiation source container.
